(19) United States
(12) Patent Application Publication
(10) Pub. No.: US 2016/0016770 A1
(43) Pub. Date: Jan. 21, 2016

(54) APPARATUS AND ASSEMBLY FOR LIFTING AND TIPPING A LIPPED BARREL OR DRUM

(71) Applicant: Robert L. Bork, Burlington, WI (US)

(72) Inventor: Robert L. Bork, Burlington, WI (US)

(21) Appl. No.: 14/331,938

(22) Filed: Jul. 15, 2014

(51) Int. Cl. B66F 9/18

(52) U.S. Cl. CPC B66F 9/186

(57) ABSTRACT

An apparatus and assembly is easily mounted to a vehicle of the type that is often used to lift objects, such as a fork truck. The apparatus and assembly is configured with a front end that has two opposing forks, or support members. Situated on top of each support member is a hinged plate. Each hinged plate is normally disposed in a horizontal plane, but can be pivoted upwardly relative to a hinge. Each plate also comprises an arcuate portion that faces inwardly relative to the support members. The arcuate portions of the plates form part of a round circumferential diameter to that substantially matches the diameter of a barrel. This diameter, however, is less than the diameter of an upper rim of the barrel and is less than any horizontally-disposed reinforcing billets that are defined in the sidewalls of the barrel.

### FIELD OF THE INVENTION

This invention relates generally to lifting devices and assemblies, including lifting devices and assemblies that are attachable to a movable piece of equipment, or a “lift vehicle” such as a tractor, a front end loader, a skidster, a fork lift truck and the like. This invention also relates generally drum or barrel handling devices. It also relates to such barrels or drums that are made of metal or plastic material. More specifically, the present invention relates to a lifting device and assembly that can be used to lift 55-gallon barrels or drums and to tip such barrels or drums so as to empty the fluid contents from them as may be desired or required.

### BACKGROUND OF THE INVENTION

55 gallon drums and barrels are well known and are generally used for the transportation and storage of liquids and powders. Such barrels or drums typically comprise a cylinder that defines a perimeter and an outer surface or sidewall, a plurality of horizontally-disposed reinforcing ridges, or billets, that are defined in the cylinder or sidewall, an upper lip, a lower lip and an integral bottom. For the remainder of this disclosure, such drums or barrels will be referred to collectively as “barrels.” Such barrels may also comprise a top cover which may or may not be removable. Either way, the barrel cover often has a pour spout defined in it for dispensing the contents of the barrel when the barrel is tipped. Such barrels can be made of metal but can also be made of a rigid plastic material.

There are a number of 55-gallon barrel lifting devices known in the art. In the experience of this inventor, many such barrel lifting or handling devices utilize a set of opposing arms that, pneumatically, electrically or hydraulically, grab the barrel around its periphery. Such devices are generally claw-like in construction and can be quite complex in design. They are also dependent on air, electricity or hydraulic fluid for actuation of the arms to grab the barrel and to release it.

In the experience of this inventor, other barrel lifting or handling devices use some sort of lip-clamping mechanism to grab a small portion of the upper barrel lip to lift and move the barrel. Unlike the devices that use opposing arms, the lip-clamping type of mechanism is typically unsuitable for tipping the barrel in any reliable way.

In the view of this inventor, there is a need to provide a barrel lifting and tipping apparatus and assembly that accomplishes the task of securely grabbing the barrel about its peripheral lip such that it can be moved and tipped. It would also be desirable to configure such an apparatus and assembly that is relatively simple in its construction while being reliable in its use. It would further be desirable to configure such an apparatus and assembly such that it can be easily mounted to and removed from a vehicle of the type that is often used to lift objects, such as a fork truck. It would also be desirable to configure such an apparatus and assembly such that it can be used with both metal barrels as well as plastic barrels.

### SUMMARY OF THE INVENTION

The apparatus and assembly of the present invention has obtained these objects. It provides for an apparatus and assembly that can be easily mounted to and removed from a vehicle of the type that is often used to lift objects, such as a tractor, a front end loader, a skidster, a fork lift truck and the like. The apparatus and assembly is configured with a front end that has two opposing forks, or support members. Situated on top of each support member is a hinged plate. Each hinged plate is normally disposed in a horizontal plane, but can be pivoted upwardly relative to a hinge. Each plate also comprises an arcuate portion that faces inwardly relative to the support members. The arcuate portions of the plates form part of a round circumferential diameter that substantially matches the diameter of a barrel. This diameter, however, is less than the diameter of an upper rim of the barrel and is less than any horizontally-disposed reinforcing ridges that are defined in the sidewalls of the barrel. More specifically, a typical 55 gallon metal barrel is about 23 inches in diameter and about 35 inches tall. The top lip (which can also be called an edge, brim or chime) extends outwardly from the diameter of the barrel top about 3/16ths of an inch, although lips can extend anywhere from between about ¼ and ⅜ths of an inch outwardly from the diameter of the barrel top.

In use, the apparatus of the present invention is positioned above a barrel with one support member disposed to either side of the barrel. As the apparatus is lowered in a substantially vertical motion, the hinged plates are rotated upwardly by virtue of their contact with the rim of the barrel. Once the plates have been lowered to a point that each clears the top lip of the barrel, the plates will drop back down into their horizontal position. Elevation of the plates then results in the top lip being contacted from beneath a good portion of the perimeter of the top lip by the plates such that the barrel can be lifted. In an additional embodiment, a strap or other securement can be used to retain the barrel within the apparatus such that the barrel can be tilted or tipped once elevated, allowing the barrel contents to be emptied. The foregoing and other features of the present invention will be apparent from the detailed description that follows.

### BRIEF DESCRIPTION OF THE DRAWINGS

FIG. 1 is a top, front and left side perspective view of a barrel lifting apparatus that is constructed in accordance with the present invention.

FIG. 2 is a view similar to that shown in FIG. 1 and showing the apparatus as it would be attached to a piece of moving equipment, the moving equipment piece being shown in phantom view.

FIGS. 3 through 6 show a sequence of front views of a portion of the apparatus illustrating how it can be used to elevate a barrel.

FIG. 7 is a view similar to that shown in FIG. 2 and illustrating that the barrel is secured within the apparatus.

FIG. 8 is a view similar to the views shown in FIGS. 2 and 7 and illustrating how the apparatus can be used to lift and then tip the barrel once it is elevated.

### DETAILED DESCRIPTION

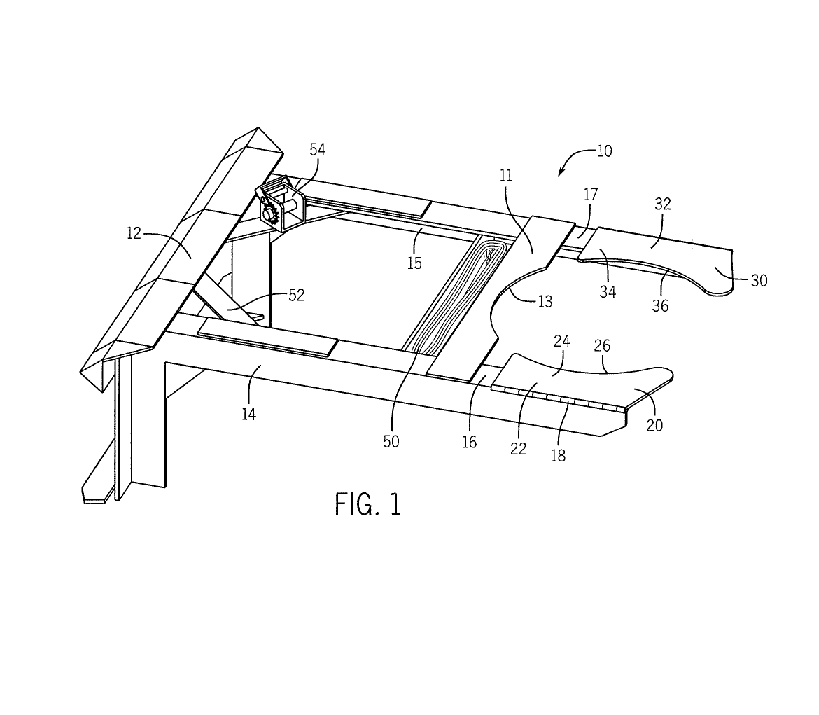

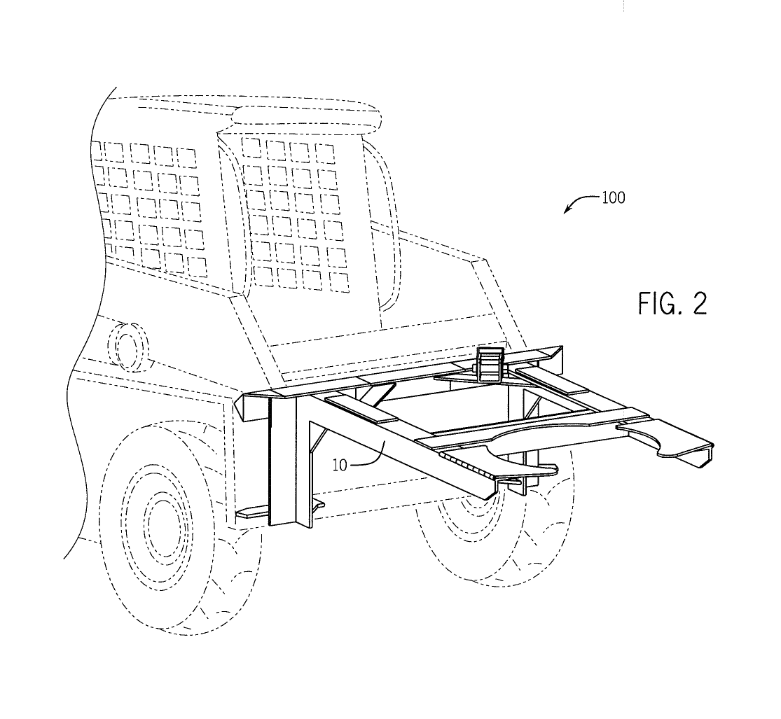

Referring now to the drawings in detail wherein like numbers represent like elements throughout, FIG. 1 illustrates a schematic view of a barrel-lifting apparatus, generally identified 10, which is constructed in accordance with the present invention. The apparatus 10, when used with a lift vehicle 1, becomes part of an assembly 100, with the apparatus 10 becoming a subassembly thereof relative to the vehicle 1. See FIG. 2. As used in this disclosure and in the claims that follow, it is to be understood that a “lift vehicle” comprises a tractor, a front end loader, a skidster, a fork lift truck or the like.

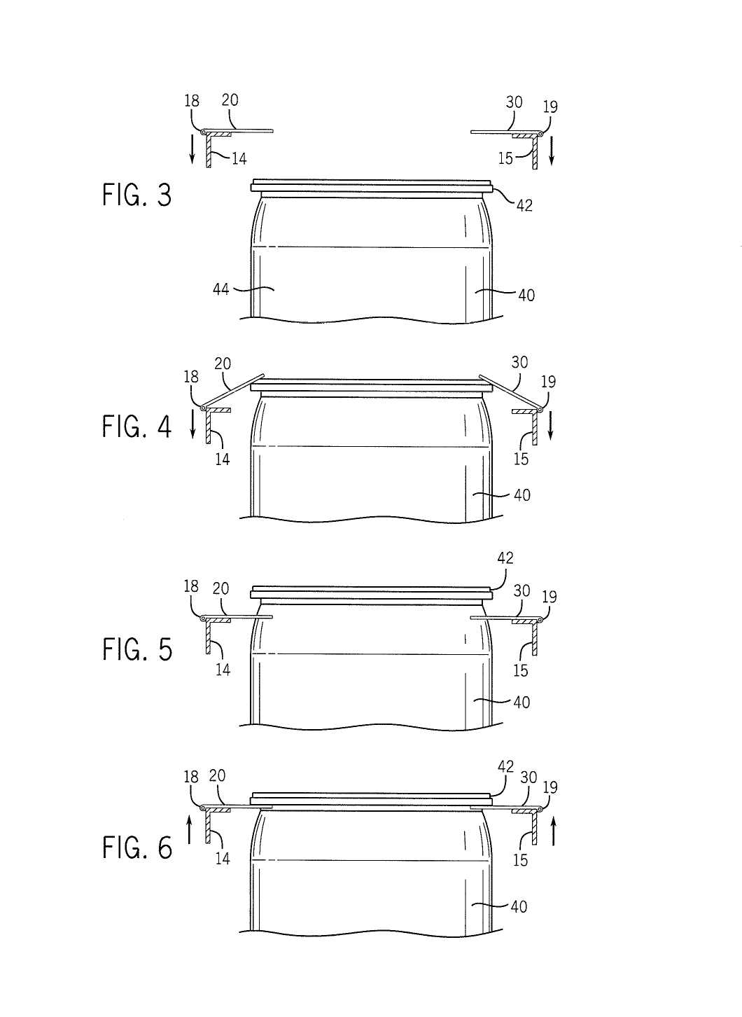

The barrel-lifting apparatus 10 includes a framework having a primary horizontal rear support portion 12 and a pair of opposing and forwardly-extending horizontal support members 14, 15. Situated on the top surface 16, 17 of each support member 14, 15 is a hinged lift plate 20, 30. Each hinged lift plate 20, 30 is normally disposed in a horizontal plane, as is shown in FIG. 1, but can be pivoted upwardly via a hinge 18, 19 that is attached to the outermost side edge 22, 32 of the lift plate 20, 30. See FIG. 3. Significantly, however, the lift plates 20, 30 are unable to drop below the horizontal in their respective downward movement. This is due to the placement of the hinges 18, 19 at the outer edges 22, 32 of the plates 20, 30 and the support members 14, 15, respectively. That is, the lift plates 20, 30 can freely rotate upwardly, but the lift plates 20, 30 are prevented from any downward rotation below the horizontal due to their contact with the top surfaces 16, 17 of the support members 14, 15, and their placement relative to the hinges 18, 19, respectively. See also FIGS. 5 and 6, in particular.

Each lift plate 20, 30 also comprises an innermost edge 24, 34, each of which further comprises an arcuate edge portion 26, 36 having a radius that is substantially the same as the radius of a barrel 40. See FIG. 3. Further, the arcuate edge portions 26, 36 face each other—inwardly relative to the support members 14, 15. In this configuration, the arcuate edge portions 26, 36 of the lift plates 20, 30 form, to a large extent, portions of a round circumferential perimeter that substantially matches the diameter of the barrel 40. Again, see FIG. 3. This diameter, however, is slightly less than the diameter of an upper lip 42 of the barrel 40. Again, the top lip 42 extends outwardly from the barrel top by a distance of about 3/16ths of an inch, although lips 42 can extend anywhere from between about ¼ and ⅜ths of an inch outwardly from the barrel top. Put another way, the diameter of the upper lip 42 is slightly greater than that of the diameter of the barrel 40. In this disclosure, the term “slightly greater” means a distance of about 3/16ths inches in radius and ⅜ths inches in diameter. Further, the diameter of the arcuate edge portions 26, 36 of the lift plates 20, 30 is also less than the diameter of any horizontally-disposed reinforcing ridge, bloom or billet (not shown) that may be defined in the continuous sidewall 44 of the barrel 40.

Lastly, a secondary horizontal support portion 11 extends between the support members 14, 15. It is to be noted that this secondary horizontal support portion 11 also comprises an arcuate portion 13 which is also part of the round circumferential barrel radius that is mentioned above. It is also to be noted that, unlike the lift plates 20, 30, the secondary horizontal support portion 11 is stationary in that it does not move relative to other portions of the framework of the apparatus 10.

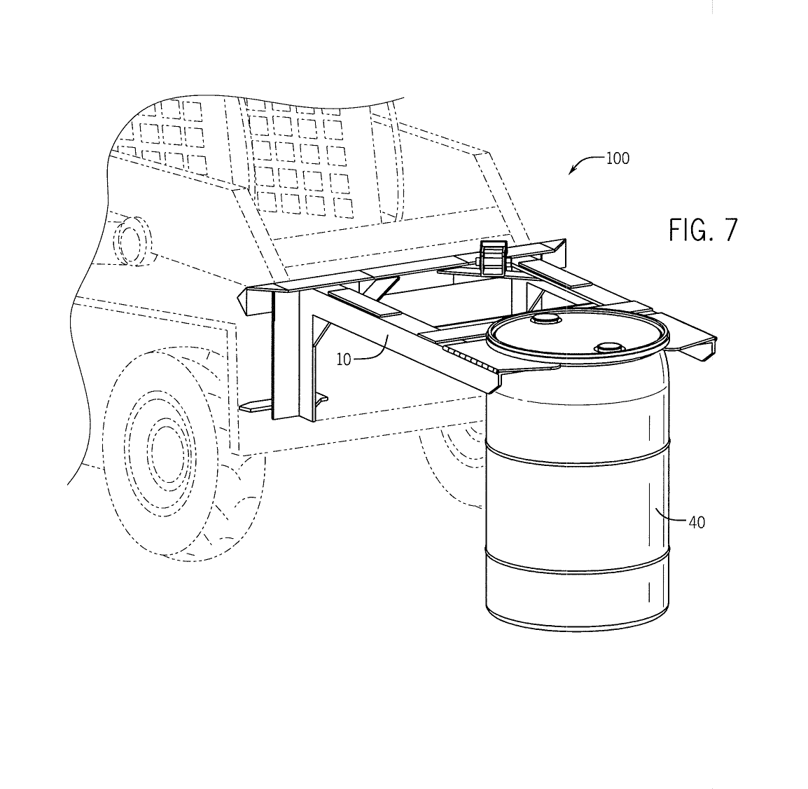

In use, the barrel-lifting apparatus 10 is positioned above a barrel 40 with one forwardly-extending support member 14, 15 and its corresponding lift plate 20, 30 disposed to opposing sides of the barrel 40. See FIG. 3. As the apparatus 10 is lowered in a substantially vertical motion and direction, the hinged lift plates 20, 30 are rotated upwardly and about their respective hinges 18, 19 by virtue of their contact with the rim 42 of the barrel 40. See FIG. 4. Once the lift plates 20, 30 have been lowered to a point that each clears the rim or lip 42 of the barrel 40, the plates 20, 30 will drop back down, returning to their horizontal position, a position in which further downwardly movement is prevented. See FIG. 5. Elevation of the apparatus 10 and the lift plates 20, 30 results in the “capturing” of the rim or lip 42 by the arcuate edge portions 26, 36 of the lift plates 20, 30 and by the arcuate portion 13 of the secondary horizontal support portion 11 of the apparatus 10. See FIGS. 6 and 7.

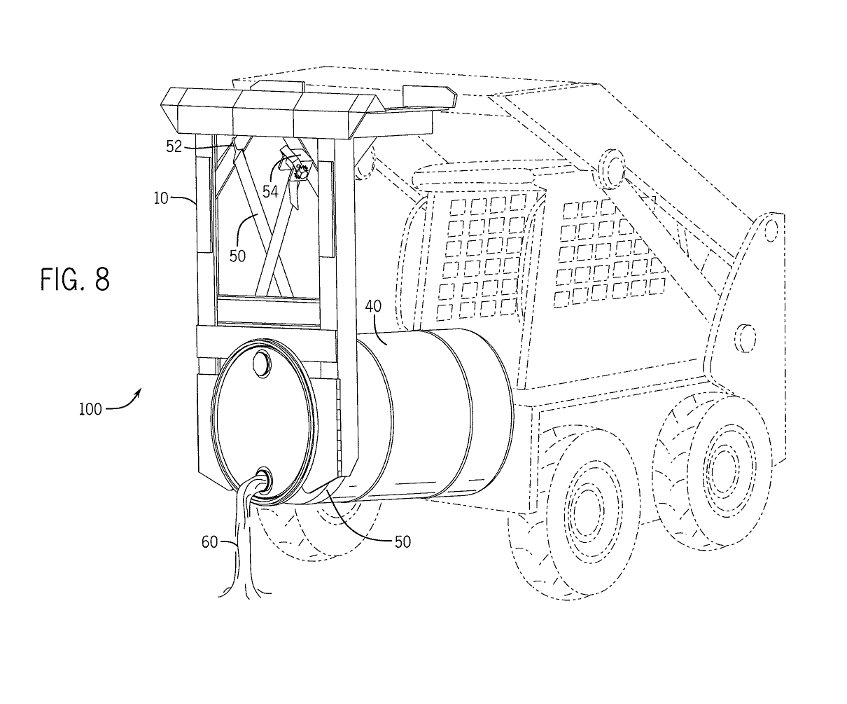

As shown in FIG. 8, the barrel-lifting apparatus 10 also comprises means for tilting the barrel 40 once the barrel 40 is lifted. That is, a strap or other securement 50 can be used to retain the barrel 40 within to the apparatus 10 such that the barrel 40 can be tilted or tipped once elevated, thereby allowing some or all of the (typically fluid) contents 60 of the barrel 40 to be emptied. The strap 50 is anchored to a first point 52 on the framework of the apparatus 10. The strap 50 is then wrapped, in somewhat of a “Figure 8” fashion about the girth of the barrel 40 and anchored to a second point 54, which second point 54 can include a ratchet or other tightening mechanism to remove any slack from the strap 50. In this way, the barrel or barrel 40 is prevented from backing out of the lift plates 20, 30 which it would tend to do without the securement of the strap 50 or like restraining structure.

In an assembly 100 of the present invention, it is to be understood that the apparatus 10 would be used, and properly adapted for use, with a fork lift or other utility vehicle 1 of conventional manufacture. The assembly 100 of the present invention is not limited to any one type of utility vehicle 1, but can instead be adapted for use with many.

The details of the invention having been disclosed in accordance with the foregoing, I claim:

1. A barrel-lifting apparatus comprising:
a rearward support portion;
a pair of opposing and forwardly-extending support members, each support member extending forwardly of the rearward support portion and having a top surface; and
a lift plate hingedly attached to the top surface of each support member, each plate being configured to rotate upwardly relative to the top surface of the support member and each plate comprising an arcuate edge.

2. The apparatus of claim 1 wherein the apparatus is used to lift a barrel, the barrel comprising a cylindrical portion and an upper lip, the upper lip of the barrel having a diameter that is slightly greater than that of the cylindrical portion and wherein the arcuate edge of each lift plate substantially matches the diameter of the cylindrical portion of the barrel.

3. The apparatus of claim 2 further comprising a secondary horizontal support portion which also comprises an arcuate portion that substantially matches the diameter of the arcuate edges of the lift plates.

4. The apparatus of claim 1 further comprising means for tilting a barrel once the barrel is lifted.

5. The apparatus of claim 4 wherein the barrel comprises a cylindrical portion and a billet, the billet of the barrel having a diameter that is slightly greater than that of the cylindrical portion, the apparatus further comprising a means for securing the barrel during tilting.

6. The apparatus of claim 5 wherein the barrel securement means comprises a strap and strap anchoring points included within the apparatus.

7. A barrel-lifting assembly comprising:
a lift vehicle;
a barrel-lifting subassembly attached to the lift vehicle, the barrel-lifting subassembly comprising:
a barrel-lifting rearward support portion;
a pair of opposing and forwardly-extending support members, each support member extending forwardly of the rearward support portion and having a top surface; and
a lift plate hingedly attached to the top surface of each support member, each plate being configured to rotate upwardly relative to the top surface of the support member and each plate comprising an arcuate edge.

8. The assembly of claim 7 wherein the subassembly is used to lift a barrel, the barrel comprising a cylindrical portion and an upper lip, the upper lip of the barrel having a diameter that is slightly greater than that of the cylindrical portion and wherein the arcuate edge of each lift plate substantially matches the diameter of the cylindrical portion of the barrel.

9. The subassembly of claim 8 further comprising a secondary horizontal support portion which also comprises an arcuate portion that substantially matches the diameter of the arcuate edges of the lift plates.

10. The assembly of claim 9 wherein the subassembly further comprises means for tilting a barrel once the barrel is lifted.

11. The subassembly of claim 10 wherein the barrel comprises a cylindrical portion and a billet, the billet of the barrel having a diameter that is slightly greater than that of the cylindrical portion, the apparatus further comprising a means for securing the barrel during tilting.

12. The subassembly of claim 11 wherein the barrel securement means comprises a strap and strap anchoring points that are included within the apparatus.
